(19) United States
(12) Patent Application Publication
(10) Pub. No.: US 2021/0041740 A1
(43) Pub. Date: Feb. 11, 2021

(54) DISPLAY DEVICE

(71) Applicant: SHARP KABUSHIKI KAISHA, Osaka (JP)

(72) Inventor: Shunhou KOU, Osaka (JP)

(21) Appl. No.: 16/945,048

(22) Filed: Jul. 31, 2020

Related U.S. Application Data
(60) Provisional application No. 62/882,847, filed on Aug. 5, 2019.

(51) Int. Cl. G02F 1/1333; G02F 1/13357; B60K 35/00

(52) U.S. Cl. CPC G02F 1/133308; G02F 1/1336; B60K 2370/33; B60K 2370/80; B60K 2370/1523; B60K 35/00

(57) ABSTRACT

A display device includes a display panel, a lighting device, and a storage member. The storage member includes a first case that has a first side portion surrounding the display panel, a second case that is formed into a box shape so as to be opened toward a side of the first case, and that has a bottom portion and a second side portion which projects from an outer end of the bottom portion and at least a part of which is overlapped with the first side portion in side view, and an interposition member which is interposed between the lighting device and the bottom portion and at least a part of which is overlapped with the first side portion and the second side portion in side view.

### CROSS-REFERENCE TO RELATED APPLICATION

The present application claims priority to U.S. Provisional Application Ser. No. 62/882,847, filed Aug. 5, 2019, the content to which is hereby incorporated by reference into this application.

### BACKGROUND OF THE INVENTION

### 1. Field of the Invention

The present disclosure relates to a display device.

### 2. Description of the Related Art

As a housing used for a liquid crystal display device, one described in Japanese Patent No. 3995410 is conventionally known. A housing described in Japanese Patent No. 3995410 includes a first case (front case) and a metal frame (rear case). The front case is a frame member that surrounds a display surface of a liquid crystal cell (liquid crystal panel) and the rear case is a storage member in which a front light unit (backlight device) that irradiates the liquid crystal panel with light, or the like is stored. The front case and the rear case are fixed by a fitting structure. Specifically, a hook portion that is formed in the front case so as to be projected is snap-engaged with an engagement portion in a slit shape, which is punched out of a side plate of the rear case, so that both the cases are fitted with each other.

### SUMMARY OF THE INVENTION

According to a liquid crystal display device configured as described above, the engagement portion that is punched out is a hole in a slit shape, so that light may leak therefrom. In a case where dimensional accuracy of the engagement portion and the hook portion is low, noise (audible noise) may be generated due to vibration, for example, from a part where the engagement portion contacts the hook portion. Since the vibration is always generated for use in a vehicle, audible noise is particularly a problem in a liquid crystal display device for use in the vehicle.

A technique described in the specification of the present application is completed under such circumstances and an object is to suppress light leakage and audible noise.

(1) A display device related to a technique described in the specification of the present application includes: a display panel in which an image is displayed; a lighting device that irradiates the display panel with light; and a storage member that has an inner space where the display panel and the lighting device are stored, in which the storage member includes a first case that has a first side portion surrounding an outer edge of the display panel, a second case that is formed into a box shape so as to be opened toward a side of the first case, and that has a bottom portion and a second side portion which projects from an outer end of the bottom portion and at least a part of which is overlapped with the first side portion in side view, and an interposition member which is interposed between the lighting device and the bottom portion and at least a part of which is overlapped with the first side portion and the second side portion in side view, in the storage member, in a part where the first side portion, the second side portion, and the interposition member are overlapped with each other in side view, a plurality of main screw holes through which the first side portion, the second side portion, and the interposition member communicate are provided, and a plurality of main screws are inserted through the plurality of main screw holes toward the inner space.

(2) Moreover, in the display device, in addition to (1) described above, a notch portion may be provided in the second side portion, in the storage member, in parts for overlapping with an inside of the notch portion in side view, a plurality of secondary screw holes through which the first side portion and the interposition member communicate may be provided, and a plurality of secondary screws may be inserted through the plurality of secondary screw holes toward the inner space.

(3) Moreover, in the display device, in addition to (1) or (2) described above, the first case and the second case may be each formed into a rectangular shape as a whole in plan view, the first case and the second case may be overlapped with each other so that corner portions of the first case and the second case are matched, and the interposition member may be formed into an L-shape in plan view and arranged in each of the corner portions.

(4) Moreover, in the display device, in addition to (3) described above, the interposition member may have an outer surface overlapped with the first side portion and the second side portion in side view, and when a part of the outer surface on a side of one of side portions forming the L-shape is defined as a first outer surface and another part of the outer surface on a side of another of side portions is defined as a second outer surface, the plurality of main screws may be provided so that a main screw is provided in the first outer surface and a main screw is provided in the second outer surface.

(5) Moreover, in the display device, in addition to (4) described above, the plurality of main screws may be provided so that a main screw is provided on an open end side of the first outer surface and a main screw is provided on an open end side of the second outer surface.

(6) Moreover, in the display device, in addition to any one of (3) to (5) described above, a notch portion may be provided in the second side portion, in the storage member, in parts for overlapping with an inside of the notch portion in side view, a plurality of secondary screw holes through which the first side portion and the interposition member communicate may be provided, a plurality of secondary screws may be inserted through the plurality of secondary screw holes toward the inner space, the interposition member may have the outer surface overlapped with the first side portion and the second side portion in side view, and when a part of the outer surface on the side of one of the side portions forming the L-shape is defined as the first outer surface and another part of the outer surface on a side of another of the side portions is defined as the second outer surface, the plurality of secondary screws may be provided so that a secondary screw is provided in the first outer surface and a secondary screw is provided in the second outer surface and that the secondary screw in the first outer surface is provided on a side of a connection end with the second outer surface and the secondary screw in the second outer surface is provided on a side of a connection end with the first outer surface.

(7) Moreover, in the display device, in addition to any one of (1) to (6) described above, a through hole may be provided in the bottom portion, and a columnar member may be provided at a position overlapping with the through hole in plan view.

(8) Moreover, in the display device, in addition to (7) described above, the columnar member may be arranged closer to a center of the lighting device than the interposition member is arranged in plan view.

(9) Moreover, in addition to any one of (1) to (8) described above, the display device may be a display device for use in a vehicle.

(10) Moreover, in addition to (7) or (8) described above, the display device may be a display device for use in a vehicle, in which the columnar member may be used as a connection portion with a vehicle body.

(11) Moreover, in addition to any one of (1) to (10) described above, in the display device, the display panel may be a liquid crystal panel.

### ADVANTAGEOUS EFFECTS OF INVENTION

According to the technique described in the specification of the present application, light leakage and audible noise are able to be suppressed.

### BRIEF DESCRIPTION OF THE DRAWINGS

FIG. 1 is a perspective view of a liquid crystal display device according to a first embodiment.

FIG. 2 is a sectional view taken along a line II-II in FIG. 1.

FIG. 3 is a sectional view taken along a line in FIG. 1.

FIG. 4 is a perspective view of an interposition member, a main screw, and a secondary screw.

FIG. 5A is a perspective view illustrating an assembling process of the liquid crystal display device of FIG. 1.

FIG. 5B is a top view of FIG. 5A.

FIG. 6A is a perspective view illustrating the assembling process subsequent to that of FIG. 5A.

FIG. 6B is a top view of FIG. 6A.

FIG. 7 is a partial side view of FIG. 6A

FIG. 8 is a perspective view illustrating the assembling process subsequent to that of FIG. 6A.

FIG. 9 is a perspective view illustrating the assembling process subsequent to that of FIG. 8.

FIG. 10 is a partial side view of FIG. 9.

### DETAILED DESCRIPTION OF THE INVENTION

### First Embodiment

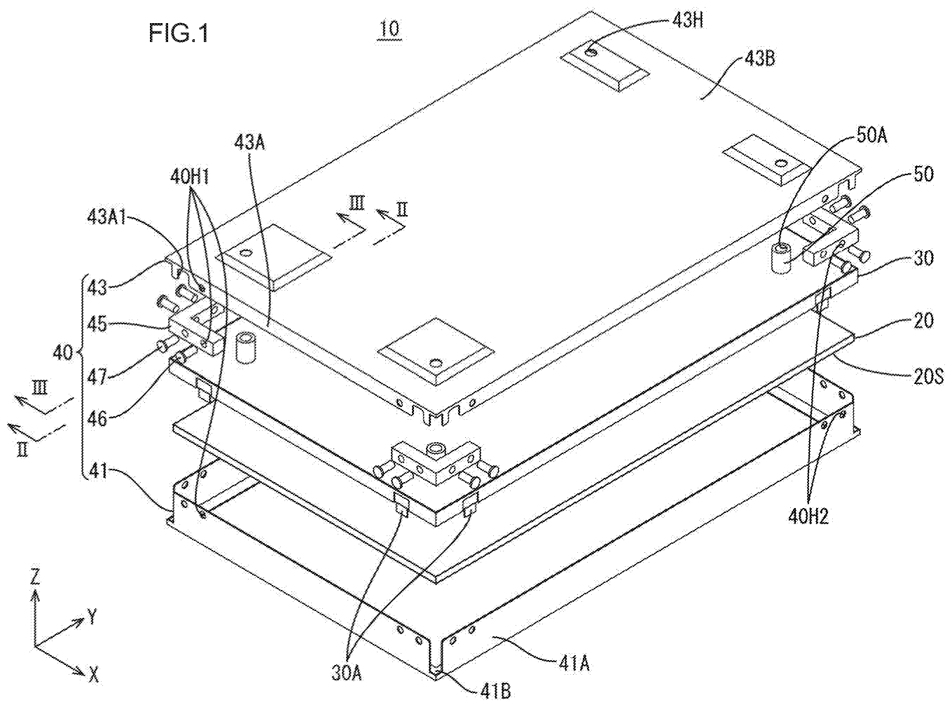

A liquid crystal display device (an example of a display device) 10 according to a first embodiment and an assembling method thereof will be described with reference to FIGS. 1 to 10. Note that, an X axis, a Y axis, or a Z axis is illustrated at a part of each of drawings and an X-axis, Y-axis, or Z-axis direction represents a direction common in the drawings. Moreover, a liquid crystal panel 20 (an example of a display panel) side and a backlight device 30 (an example of a lighting device) side in the liquid crystal display device 10 are respectively defined as a front side and a rear side.

As illustrated in FIG. 1, the liquid crystal display device 10 is formed into a horizontally-long quadrangular (rectangular) shape as a whole in plan view. The liquid crystal display device 10 has a size (about 8 inches to 12 inches) suitable for use in a vehicle. The liquid crystal display device 10 includes the liquid crystal panel 20 in which an image is displayed, the backlight device 30, a storage member 40 that has an inner space where the liquid crystal panel 20 and the backlight device 30 are stored, and a columnar member 50 used in mounting on the vehicle. Note that, in each of the drawings, for convenience of description for the assembling method described below, a display surface of the liquid crystal display panel 20 faces downward (lower side in the drawing).

The liquid crystal panel 20 includes two substrates, a liquid crystal layer sealed in an inside of both the substrates, and a polarizer arranged outside each of the substrates. The liquid crystal layer contains a liquid crystal molecule that is a substance whose optical characteristics change with application of an electric field. In one (array substrate) of the substrates, a switching element, a pixel electrode connected to the switching element, an alignment film, and the like are provided on a glass substrate. In the other substrate (CF substrate), a color filter, an alignment film, and the like are provided on a glass substrate.

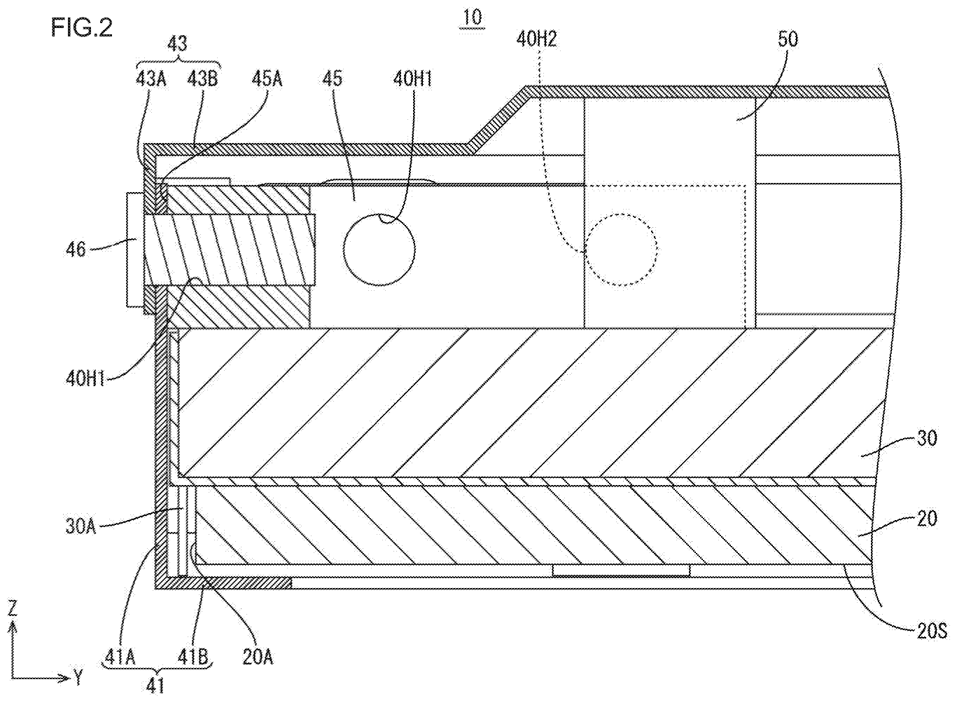

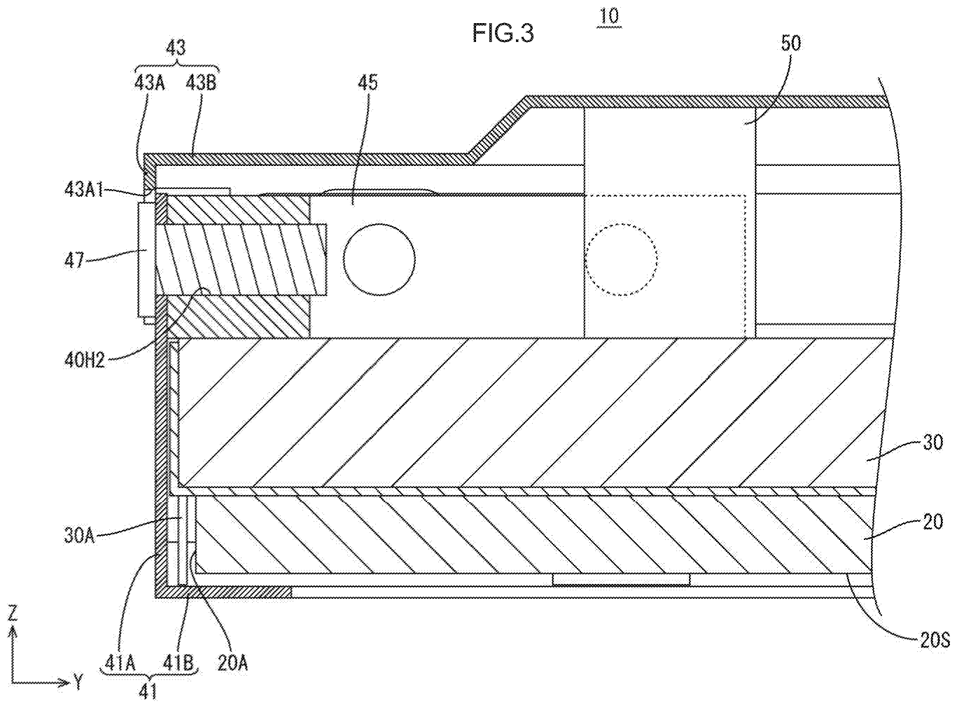

As illustrated in FIG. 1, the backlight device 30 is arranged on a rear side (opposite to the display surface) of the liquid crystal panel 20. The backlight device 30 irradiates the liquid crystal panel 20 with light in a form of a plane from a plate surface (light output surface) on a side of the liquid crystal panel 20. The backlight device 30 mainly includes an LED (an example of a light source), a light guide plate that guides light from the LED, and an optical sheet that exerts predetermined optical effect. The backlight device 30 also includes a protrusion (rib) 30A on a side of the light output surface. As illustrated in FIGS. 2 and 3, the protrusion 30A is provided between the backlight device 30 and a front case 41 (specifically, a frame portion 41B described later) so as to be adjacent to an end surface 20A of the liquid crystal panel 20. A size of the backlight device 30 is slightly larger than that of the liquid crystal panel 20 in plan view, so that a space where the protrusion 30A is able to extend is provided outside the end surface 20A. A predetermined gap between the backlight device 30 and the front case 41 is ensured by the protrusion 30A.

As illustrated in FIG. 1, the storage member 40 includes the front case 41 (an example of a first case), a rear case 43 (an example of a second case), an interposition member 45, a plurality of main screws 46, and a plurality of secondary screws 47. As illustrated in FIGS. 1 to 3, the front case 41 is arranged on the front side of the liquid crystal display device 10 and the rear case 43 is arranged on the rear side of the liquid crystal display device 10. The interposition member 45 is interposed between the backlight device 30 and the rear case 43 as illustrated in FIG. 2. The front case 41, the rear case 43, and the interposition member 45 are screwed and fixed together by the main screws 46. The front case 41 and the interposition member 45 are screwed and fixed by the secondary screws 47.

The columnar member 50 has a cylindrical shape as illustrated in FIG. 1 and four columnar members 50 are arranged in total one by one in rear-side corner portions of the backlight device 30. A position of the columnar member 50 in plan view is closer to a center of the backlight device 30 than a position of the interposition member 45. In an end of the columnar member 50, which is on a side of the rear case 43, an insertion portion 50A into which a fastener (such as a screw) used in mounting on the vehicle is inserted is formed. The columnar member 50 serves as a connection portion of a vehicle body and the liquid crystal display device 10.

The front case 41 is made of metal and formed into a rectangular frame shape as a whole in plan view as illustrated in FIG. 1. As illustrated in FIGS. 2 and 3, the front case 41 has a first side portion 41A and the frame portion 41B. The first side portion 41A is constituted by four side walls that surround four end surfaces 20A of the liquid crystal panel 20. As illustrated in FIGS. 2 and 3, a height (length in the Z-axis direction) of the first side portion 41A has such a dimension that covers a portion from an end of the protrusion 30A on the front side to at least a part of the interposition member 45 (specifically, an outer surface 45A described later). The frame portion 41B is projected in parallel with a portion from an end of the first side portion 41A on the front side to a display surface 20S of the liquid crystal panel 20. The frame portion 41B covers, in a frame shape, an outer edge of the display surface 20S.

The rear case 43 is made of metal and formed into a box shape as a whole so as to be opened toward the front side (side of the front case 41) as illustrated in FIG. 1. The rear case 43 has a second side portion 43A and a bottom portion 43B. The bottom portion 43B is formed into a rectangular shape in plan view and arranged on the rear side of the backlight device 30. The second side portion 43A projects from an outer end of the bottom portion 43B to the front side. As illustrated in FIGS. 2 and 3, a height (length in the Z-axis direction) of the second side portion 43A has such a dimension that extends from the bottom portion 43B to the interposition member 45 (specifically, the outer surface 45A described later) and is overlapped with the first side portion 41A. The rear case 43 and the front case 41 are overlapped with each other so that corner portions thereof are matched with each other in plan view and the first side portion 41A and the second side portion 43A are overlapped with each other in side view. Thereby, a space (inner space of the storage member 40) surrounded by the front case 41 and the rear case 43 is generated and the liquid crystal panel 20 and the backlight device 30 are stored in the inner space.

As illustrated in FIG. 1, the bottom portion 43B includes a through hole 43H, which passes through the bottom portion 43B, in a part where the bottom portion 43B is overlapped with the columnar member 50 in plan view. In mounting on the vehicle, the fastener by which the liquid crystal display device 10 is connected to the vehicle body is inserted into the insertion portion 50A through the through hole 43H.

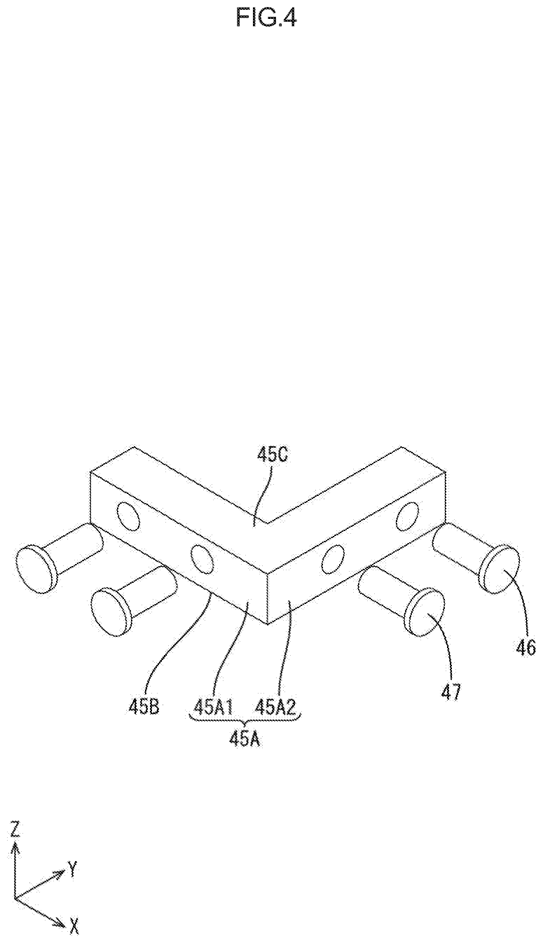

As illustrated in FIGS. 1 and 4, the interposition member 45 is formed into an L-shape, in which two side portions having an equal length are connected at right angles, in plan view. Four interposition members 45 are arranged in total one by one in inner-side corner portions of the rear case 43. As illustrated in FIGS. 2 and 3, the interposition members 45 are interposed between the corner portions of the bottom portion 43B of the rear case 43 and the backlight device 30. Each of the interposition members 45 has the outer surface 45A that is overlapped with the first side portion 41A and the second side portion 43A in side view, a front surface 45B that faces the backlight device 30, and a rear surface 45C that is opposite to the front surface 45B and faces the bottom portion 43B. In the outer surface 45A, an outer surface 45A on a side of one of the side portions that form the L-shape is defined as a first outer surface 45A1 and an outer surface 45A on a side of the other side portion is defined as a second outer surface 45A2.

In the storage member 40, in a part where the first side portion 41A of the front case 41, the second side portion 43A of the rear case 43, and the outer surface 45A of the interposition member 45 are overlapped with each other in side view, a plurality of main screw holes 40H1 through which the respective portions 41A, 43A, and 45A communicate are formed as illustrated in FIGS. 1 and 2. Each of the main screws 46 is inserted through each of the main screw holes 40H1 toward the inner space of the storage member 40. As a result, the front case 41, the rear case 43, and the interposition member 45 are screwed and fixed together.

As illustrated in FIGS. 1 and 3, a notch portion 43A1 that is cut out in a rectangular shape from the front side is formed in the second side portion 43A. In the storage member 40, in parts for overlapping with an inside of the notch portion 43A1 in side view, a plurality of secondary screw holes 40H2 through which the first side portion 41A and the outer surface 45A communicate are formed. Each of the secondary screws 47 is inserted through each of the secondary screw holes 40H2 toward the inner space of the storage member 40.

As illustrated in FIG. 4, the plurality of main screws 46 and the plurality of secondary screws 47 are provided so that one main screw 46 and one secondary screw 47 are provided in each of the first outer surface 45A1 and the second outer surface 45A2 in the L-shape of each of the interposition members 45. In the first outer surface 45A1, the secondary screw 47 is provided on a side of a connection end that is connected to the other outer surface (second outer surface 45A2) and the main screw 46 is provided on a side of an open end that is not connected to the second outer surface 45A2. Also in the second outer surface 45A2, the secondary screw 47 and the main screw 46 are provided similarly.

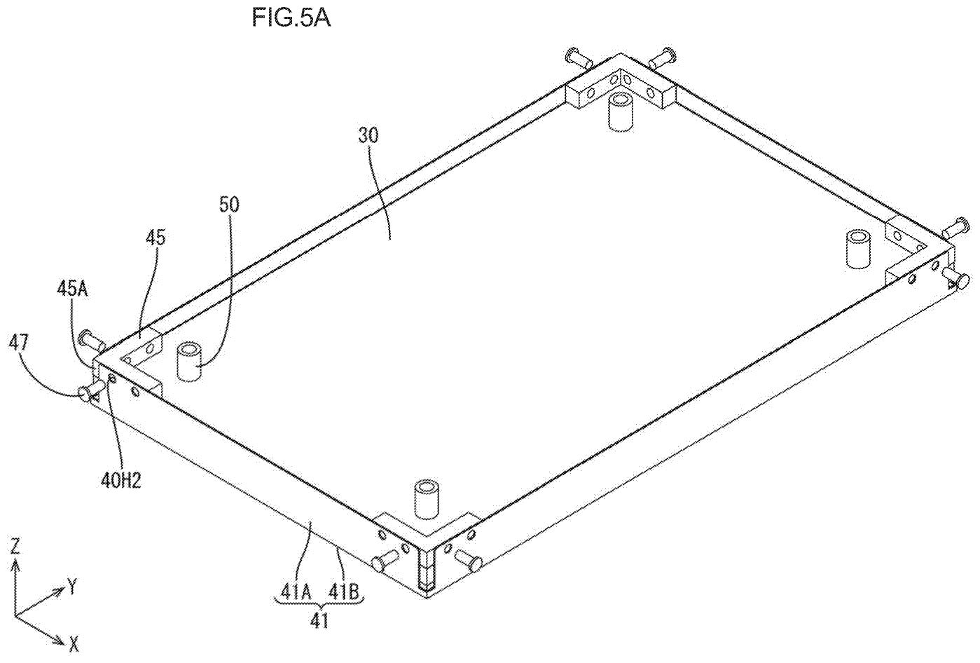

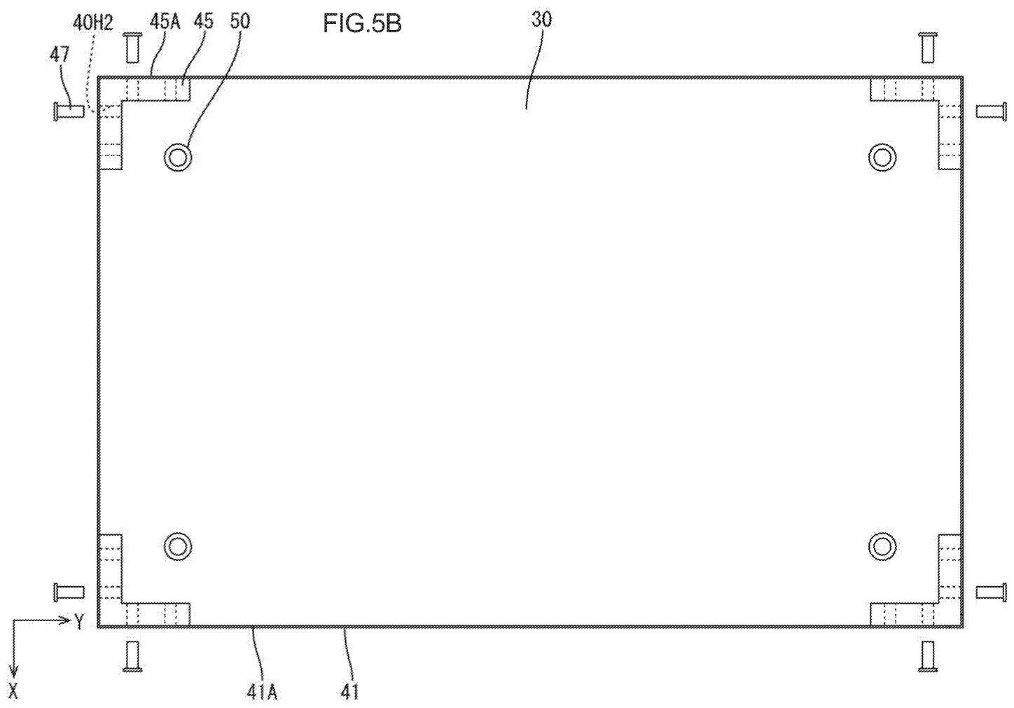

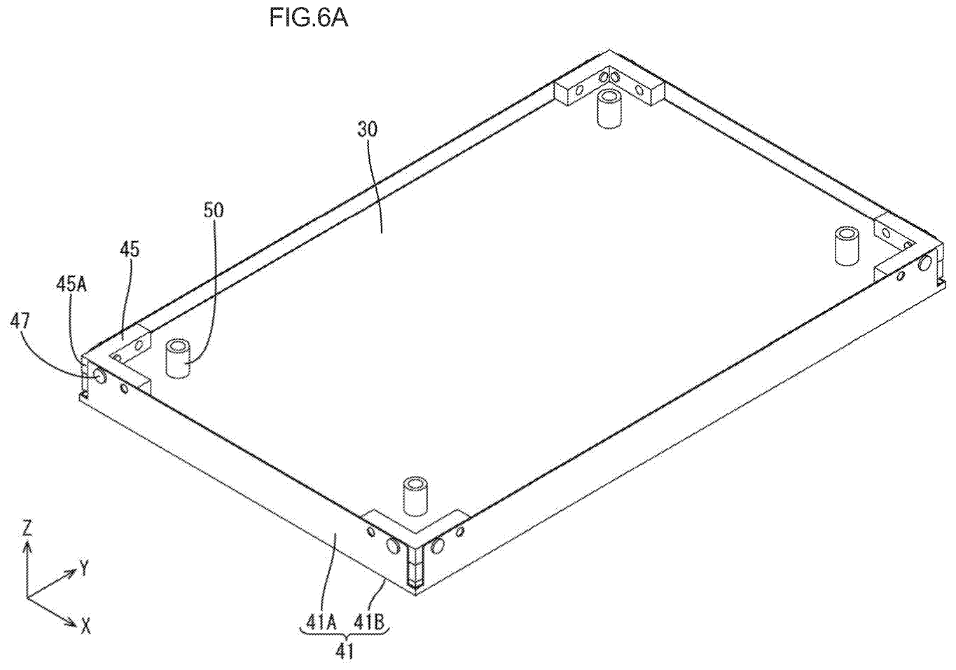

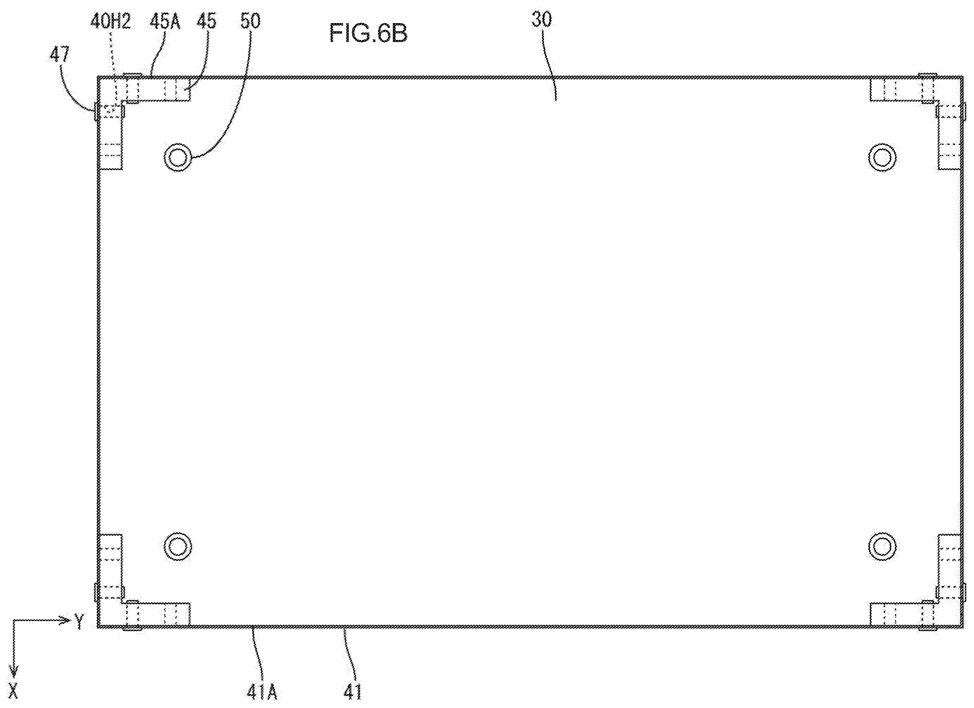

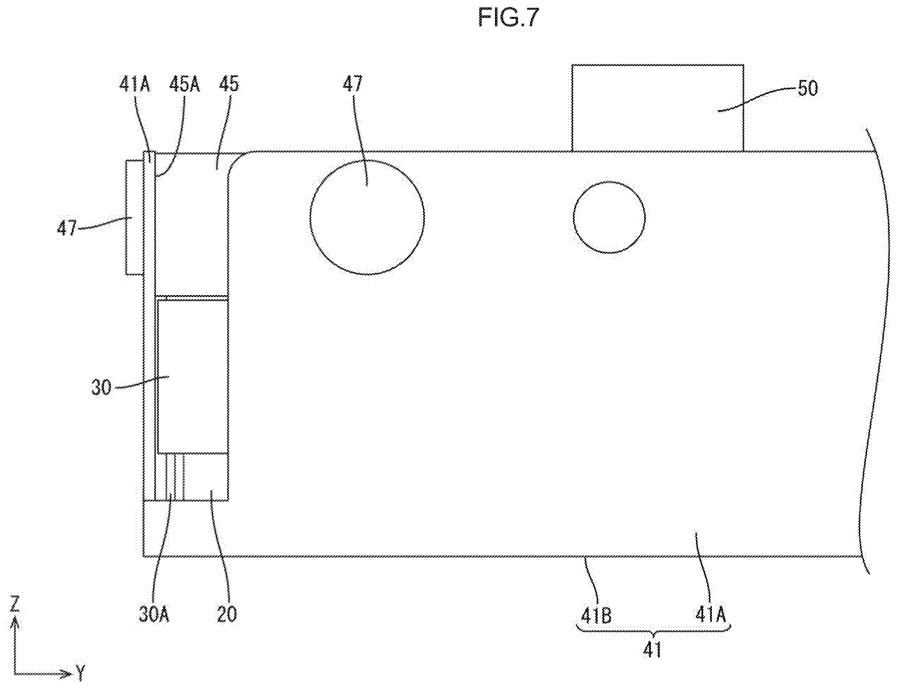

Subsequently, the assembling method of the liquid crystal display device 10 configured as described above will be described with reference to FIGS. 5A to 10. First, as illustrated in FIG. 5A, the front case 41 is arranged on a working table so that the frame portion 41B is on the lower side, and the liquid crystal panel 20 and the backlight device 30 are stacked in order on an inner side of the front case 41. They are stacked so that the display surface 20S of the liquid crystal panel 20 is on the lower side and the light output surface of the backlight device 30 is on the lower side. Next, as illustrated in FIGS. 5A and 5B, the interposition members 45 are placed one by one in the respective corner portions of the backlight device 30. At this time, the placement is performed so that the first side portion 41A of the front case 41 and the outer surface 45A of the interposition member 45 communicate through the secondary screw holes 40H2. Then, the secondary screws 47 are inserted through the secondary screw holes 40H2 toward the inner space of the storage member 40 so as to allow screwing as illustrated in FIGS. 6A, 6B, and 7. Further, the columnar member 50 is provided at a predetermined position and fixed.

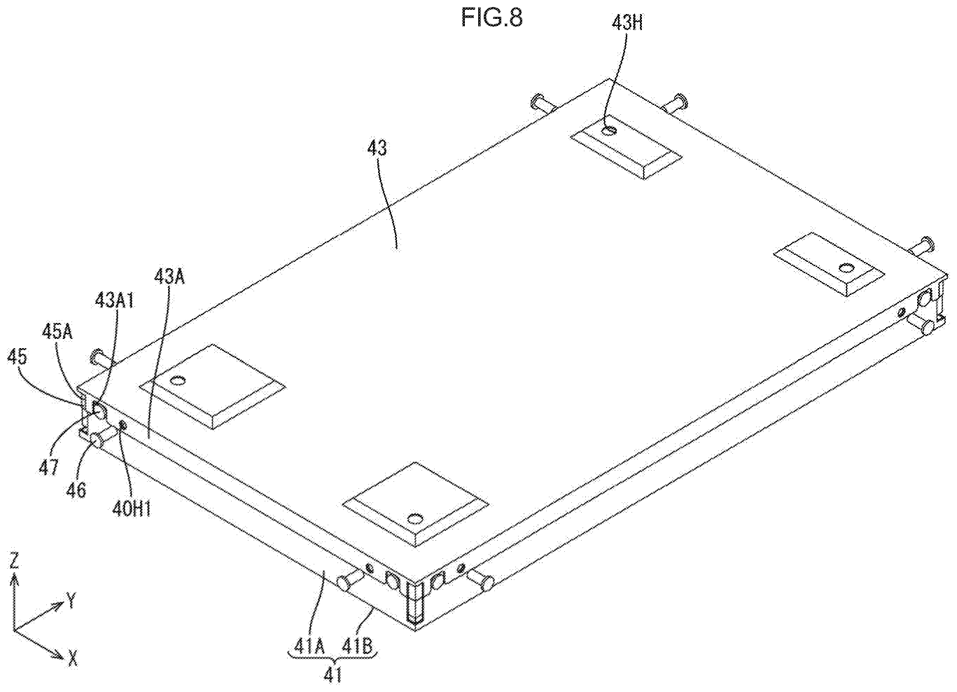

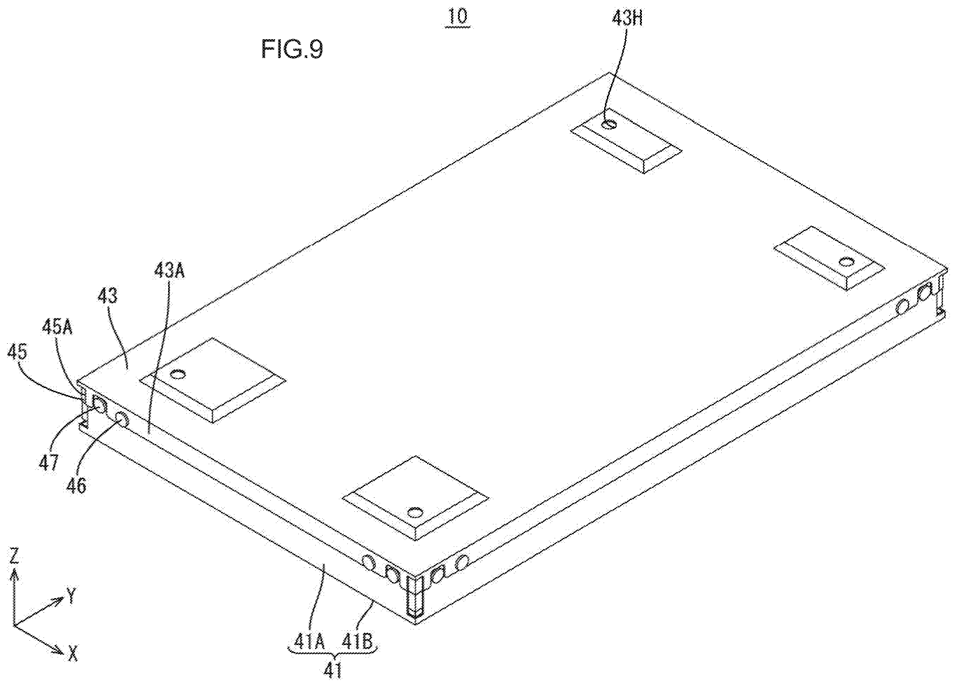

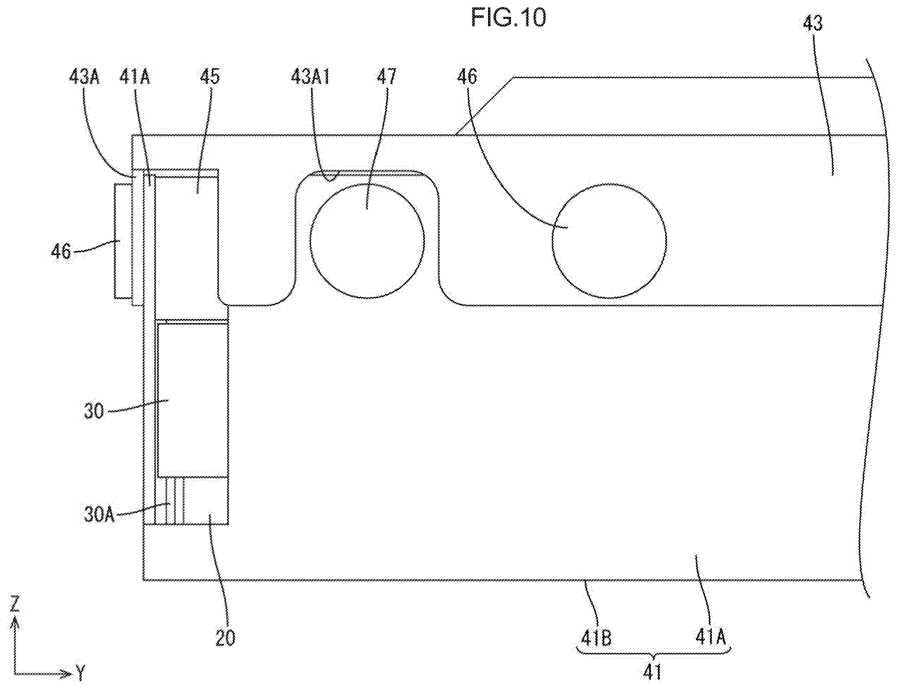

Next, as illustrated in FIG. 8, the rear case 43 is covered from an upper side of the backlight device 30. At this time, the rear case 43 is covered so that the secondary screw 47 is positioned in an inside of the notch portion 43A1 of the second side portion 43A of the rear case 43 in side view, as illustrated in FIG. 8. Further, the second side portion 43A is stacked so that the second side portion 43A communicates the outer side surface 45A and the first side portion 41A through the main screw holes 40H1. Then, the main screws 46 are inserted through the main screw holes 40H1 toward the inner space of the storage member 40 so as to allow screwing as illustrated in FIGS. 9 and 10.

According to the liquid crystal display device 10 described above, the front case 41 and the rear case 43 are screwed and fixed by using the interposition members 45 and the main screws 46, so that both the cases 41 and 43 are able to be fixed more firmly than a case where both the cases 41 and 43 are fixed by a fitting structure. As a result, generation of audible noise due to vibration or the like is able to be suppressed. Moreover, since both the cases 41 and 43 are able to be coupled accurately by screwing fixation, it is not necessary to intentionally provide a gap in a coupling structure and both the cases 41 and 43, eventually, the liquid crystal display device 10 is able to be reduced in size. Further, a main screw hole 40H1 through which a main screw 46 is inserted is closed by a screw thread of the main screw 46, thus making it possible to suppress light leakage.

Moreover, according to the liquid crystal display device 10 described above, at a time of assembling, first, the front case 41 and the interposition members 45 are fixed by the secondary screws 47, and after that, the front case 41, the rear case, and the interposition members 45 are fixed by the main screws 46. Before fixation with the main screws 46, the front case 41 and the interposition members 45 are fixed by the secondary screws 47, so that it is possible to facilitate assembling work and more firmly fix the storage member 40, that is, both the cases 41 and 43.

### Other Embodiments

A technique described in the specification of the present application is not limited to the embodiment described with reference to the aforementioned description and drawings. For example, the following embodiments are also included in a technical scope of the invention.

(1) The front case 41 and the rear case 43 may each have a shape other than the rectangular shape. In addition, in a case where they do not have the rectangular shape, the shape of the interposition member 45 in plan view may not be the L-shape. A height (length in the Z-axis direction) of the interposition member 45 and a width of a side portion thereof are examples and may have other dimensions.

(2) Respective shapes, sizes, number, and intervals of the main screw 46 and the secondary screw 47 and the main screw hole 40H1 and the secondary screw hole 40H2 through which the main screw 46 and the secondary screw 47 are respectively inserted are examples and may have other specifications.

(3) The backlight device 30 may be a direct backlight device that has a light source planarly arranged and that does not include a light guide plate.

(4) The liquid crystal display device 10 may not be used for a vehicle and a plane size thereof is not limited to about 8 inches to 12 inches.

(5) The storage member 40 is able to be applied also to a display device other than the liquid crystal display device 10.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A display device comprising:
a display panel in which an image is displayed;
a lighting device that irradiates the display panel with light; and
a storage member that has an inner space where the display panel and the lighting device are stored, wherein
the storage member includes
a first case that has a first side portion surrounding an outer edge of the display panel,
a second case that is formed into a box shape so as to be opened toward a side of the first case, and that has a bottom portion and a second side portion which projects from an outer end of the bottom portion and at least a part of which is overlapped with the first side portion in side view, and
an interposition member which is interposed between the lighting device and the bottom portion and at least a part of which is overlapped with the first side portion and the second side portion in side view,
in the storage member, in a part where the first side portion, the second side portion, and the interposition member are overlapped with each other in side view, a plurality of main screw holes through which the first side portion, the second side portion, and the interposition member communicate are provided, and
a plurality of main screws are inserted through the plurality of main screw holes toward the inner space.

2. The display device according to claim 1, wherein
a notch portion is provided in the second side portion,
in the storage member, in parts for overlapping with an inside of the notch portion in side view, a plurality of secondary screw holes through which the first side portion and the interposition member communicate are provided, and
a plurality of secondary screws are inserted through the plurality of secondary screw holes toward the inner space.

3. The display device according to claim 1, wherein
the first case and the second case are each formed into a rectangular shape as a whole in plan view,
the first case and the second case are overlapped with each other so that corner portions of the first case and the second case are matched, and
the interposition member is formed into an L-shape in plan view and arranged in each of the corner portions.

4. The display device according to claim 3, wherein
the interposition member has an outer surface overlapped with the first side portion and the second side portion in side view, and
when a part of the outer surface on a side of one of side portions forming the L-shape is defined as a first outer surface and another part of the outer surface on a side of another of side portions is defined as a second outer surface,
the plurality of main screws are provided so that a main screw is provided in the first outer surface and a main screw is provided in the second outer surface.

5. The display device according to claim 4, wherein
the plurality of main screws are provided so that a main screw is provided on an open end side of the first outer surface and a main screw is provided on an open end side of the second outer surface.

6. The display device according to claim 3, wherein
a notch portion is provided in the second side portion,
in the storage member, in parts for overlapping with an inside of the notch portion in side view, a plurality of secondary screw holes through which the first side portion and the interposition member communicate are provided,
a plurality of secondary screws are inserted through the plurality of secondary screw holes toward the inner space,
the interposition member has the outer surface overlapped with the first side portion and the second side portion in side view, and
when a part of the outer surface on the side of one of the side portions forming the L-shape is defined as the first outer surface and another part of the outer surface on a side of another of the side portions is defined as the second outer surface,
the plurality of secondary screws are provided so that a secondary screw is provided in the first outer surface and a secondary screw is provided in the second outer surface and that the secondary screw in the first outer surface is provided on a side of a connection end with the second outer surface and the secondary screw in the second outer surface is provided on a side of a connection end with the first outer surface.

7. The display device according to claim 1, wherein
a through hole is provided in the bottom portion, and
a columnar member is provided at a position overlapping with the through hole in plan view.

8. The display device according to claim 7, wherein the columnar member is arranged closer to a center of the lighting device than the interposition member is arranged in plan view.

9. The display device according to claim 1 that is a display device for use in a vehicle.

10. The display device according to claim 7 that is a display device for use in a vehicle, wherein the columnar member serves as a connection portion with a vehicle body.

11. The display device according to claim 1, wherein the display panel is a liquid crystal panel.
